(19) United States
(12) Patent Application Publication
(10) Pub. No.: US 2010/0014840 A1
(43) Pub. Date: Jan. 21, 2010

(54) Information processing apparatus and information processing method

(75) Inventor: Tsutomu Nagai, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/459,373

(22) Filed: Jun. 30, 2009

(30) Foreign Application Priority Data
Jul. 1, 2008 (JP) P2008-172594

(51) Int. Cl. H04N 5/00; H04N 7/18; G10L 11/04

(52) U.S. Cl. 386/117; 348/135; 704/207; 386/E05.003; 704/E11.006

(57) ABSTRACT

An information processing apparatus includes a viewer information input unit that receives input of information about a viewer viewing reproduced program content as viewer information by watching video displayed on a monitor or listening to a voice output from a speaker, an upsurge degree acquisition unit that acquires a degree of upsurge of the viewer based on the viewer information whose input is received by the viewer information input unit, and a highlight extraction unit that extracts highlights of the program content based on the degree of upsurge acquired by the upsurge degree acquisition unit.

### BACKGROUND OF THE INVENTION

1. Field of the Invention

The present invention relates to an information processing apparatus and an information processing method. More particularly, the present invention relates to a technology that classifies and evaluates program content and detects highlights based on results of observing viewers.

2. Description of the Related Art

An audience rating survey has been conducted as an evaluation index of program content. However, there was an issue that the audience rating survey took a lot of time and effort and also the number of samples was small. Moreover, the survey was done based on the viewing time and thus, quality of program content could hardly be said to be adequately reflected. Further, in the past circumstances in which time-shifted viewing has been generally practiced thanks to widespread use of recording/reproduction apparatuses, there was an issue that it was difficult to grasp an original audience rating of program content from an audience rating alone when a program was broadcast. Therefore, it is not appropriate to extract highlight scenes (hereinafter, referred to also as “highlights”) based on such an audience rating.

To complement such issues, a technology to detect highlights by evaluating video itself of program content is disclosed (See, for example, Patent Document 1).

[Patent Document 1] Japanese Patent Application Laid-Open No. 2007-288697

### SUMMARY OF THE INVENTION

However, according to the technology disclosed in Patent Document 1, there was an issue that highlights reflecting evaluations of a program by viewers could not be extracted because highlights were extracted by evaluating program content itself.

The present invention has been made in view of the above issues, and it is desirable to provide a technology capable of extracting highlights reflecting evaluations of a program by viewers.

According to an embodiment of the present invention, there is provided an information processing apparatus, including: a viewer information input unit that receives input of information about a viewer viewing reproduced program content as viewer information by watching video displayed on a monitor or listening to a voice output from a speaker; an upsurge degree acquisition unit that acquires a degree of upsurge of the viewer based on the viewer information whose input is received by the viewer information input unit; and a highlight extraction unit that extracts highlights of the program content based on the degree of upsurge acquired by the upsurge degree acquisition unit.

With the above configuration, it becomes possible to extract highlights of program content in accordance with the degree of upsurge of viewers. Accordingly, highlights reflecting evaluations of a program by viewers can be extracted.

According to the embodiments of the present invention described above, a technology capable of extracting highlights reflecting evaluations of a program by viewers can be provided.

### BRIEF DESCRIPTION OF THE DRAWINGS

FIG. 1 is a diagram showing a system configuration according to the present embodiment;

FIG. 2 is a diagram showing a function configuration of an information processing apparatus according to the present embodiment;

FIG. 3 is a diagram illustrating an algorithm for calculating a degree of upsurge according to the present embodiment;

FIG. 4 is a flow chart showing a flow of processing performed by the information processing apparatus according to the present embodiment; and

FIG. 5 is a diagram showing a modification of a system according to the present embodiment.

### DETAILED DESCRIPTION OF THE PREFERRED EMBODIMENTS

Hereafter, preferred embodiments of the present invention will be described in detail with reference to the appended drawings. Note that in this specification and the appended drawings, structural elements that have substantially the same functions and structures are denoted with the same reference numerals and a repeated explanation of these structural elements is omitted.

### <<System Configuration According to the Present Embodiment>>

First, the system configuration according to the present embodiment will be described to facilitate an understanding of the present embodiment.

In the present embodiment, “classification”, “evaluation”, and “highlight detection” of program content is continuously performed by acquiring not only the viewing time of program content, but also information including emotions and attributes (such as the age and sex) of viewers. Moreover, based on results thereof, a system to assist in program content selection thereafter by viewers is provided.

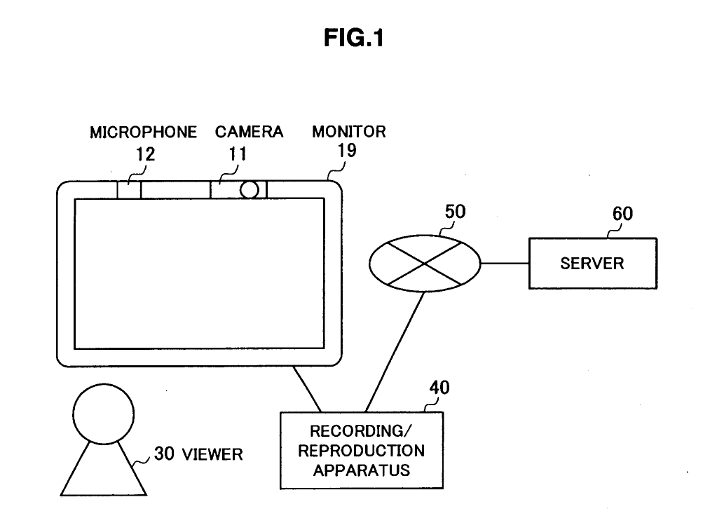

FIG. 1 is a diagram showing a system configuration according to the present embodiment. As shown in FIG. 1, it is assumed that viewers 30 are present and view program content through a monitor 19 of such as a TV set. The monitor 19 (for example, in an upper part of the monitor 19) is assumed to contain a camera 11 and a microphone 12 embedded therein or to contain the camera 11 and the microphone 12 as options. A recording/reproduction apparatus 40 is present inside the system. It is assumed that the recording/reproduction apparatus 40 is contained in or connected to the monitor 19 and a network 50 such as a home LAN (Local Area Network) and the Internet can be connected from the monitor 19 or the recording/reproduction apparatus 40.

It is assumed that a server 60 to manage information detected from program content is present beyond the network 50 to be able to receive information of many pieces of program content, perform information processing as collective knowledge, and give feedback to the viewers 30.

In the present embodiment, emotions of the viewers 30 are identified using the camera 11 and the microphone 12. The camera 11 shoots the viewers 30 to detect facial expressions from images thereof. Further, the degree of concentration and intensity of activity in program content are determined from movements of the lines of sight. Further, the number, age, sex and the like of viewers are determined from images of the camera 11 as attribute information of the viewers 30.

The microphone 12 is used to play the role of assisting in classification/evaluation by the camera and is used to determine the degree of laughing voice and tearful voice from the volume of voice and identify the sex from vocal quality. Further, the recording/reproduction apparatus 40 acquires information about performers, classification by the provider side and the like of program content from EPG (Electronic Program Guide) information or EPG link information in a network.

In classification processing, each piece of information described above is integrated to classify program content. In evaluation processing, upsurge conditions expressed numerically from facial expressions, voice and the like of the viewers 30 and chronological records thereof are defined as the degree of upsurge and quality of program content expressed numerically based on the degree and the actual number and ratio of the viewers 30 is defined as a program evaluation. Highlights are extracted by selecting a portion of particularly high degree of upsurge.

Each piece of processing of the classification, evaluation, and highlight detection can independently be performed by each monitor 19, each connected recording/reproduction apparatus 40, or each system containing the monitor 19. On the other hand, information handled as collective knowledge on the server 60 connected to the network 50 and having higher precision can be given to the viewers 30 as feedback.

With the collective knowledge being utilized by program producers or companies that desires to develop advertisements within the range of personal information protection, it becomes possible to produce more targeted programs and develop advertisements.

### Function Configuration of the Information Processing Apparatus>>

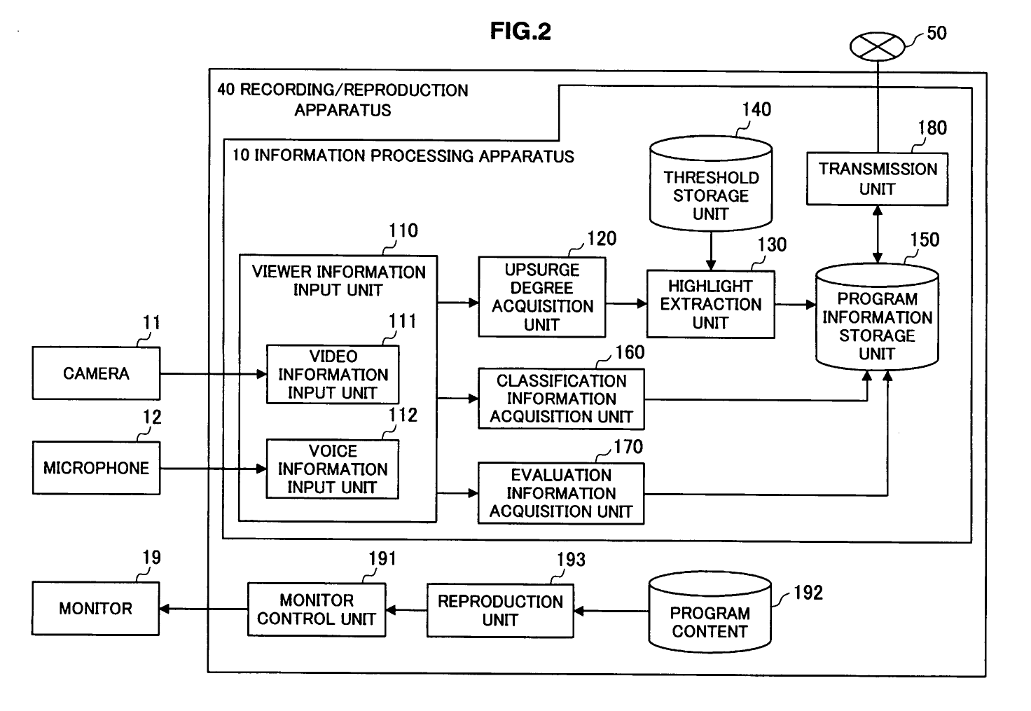

FIG. 2 is a diagram showing the function configuration of an information processing apparatus according to the present embodiment. The function configuration of the information processing apparatus according to the present embodiment will be described with reference to FIG. 2 (FIG. 1 is referenced if necessary).

As shown in FIG. 2, the information processing apparatus 10 is incorporated into the recording/reproduction apparatus 40 in the present embodiment, but the information processing apparatus 10 may not be incorporated into the recording/reproduction apparatus 40. The information processing apparatus 10 includes at least a viewer information input unit 110, an upsurge degree acquisition unit 120, and a highlight extraction unit 130. Also as shown in FIG. 2, the viewer information input unit 110 may have at least one of a video information input unit 111 and a voice information input unit 112. Alternatively, a threshold storage unit 140, a program information storage unit 150, a classification information acquisition unit 160, an evaluation information acquisition unit 170, or a transmission unit 180 may be included.

The camera 11 shoots the viewers 30 viewing reproduced program content 192 by watching video displayed on the monitor 19 or listening to voices output from a speaker (not shown) to acquire video information of the viewers 30. The camera 11 may be contained, as shown in FIG. 1, in the monitor 19 or installed near the monitor 19. The program content 192 is reproduced by a reproduction unit 193. The monitor 19 is controlled by a monitor control unit 191.

The microphone 12 acquires voices uttered by the viewers 30 to acquire voice information of the viewers 30. The microphone 12 may be contained, as shown in FIG. 1, in the monitor 19 or installed near the monitor 19.

The viewer information input unit 110 receives input of information about the viewers 30 viewing reproduced program content by watching video displayed on the monitor 19 or listening to voices output from a speaker (not shown) as viewer information.

The video information input unit 111 receives input of video information of the viewers 30 via the camera 11 as viewer information. The video information input unit 111 is constituted, for example, by a USB (Universal Serial Bus) interface or the like.

The voice information input unit 112 receives input of voice information of the viewers 30 via the microphone 12 as viewer information. The voice information input unit 112 is constituted, for example, by a USB (Universal Serial Bus) interface or the like.

The upsurge degree acquisition unit 120 acquires the degree of upsurge of the viewers 30 based on viewer information whose input is received by the viewer information input unit 110.

If the viewer information input unit 110 has the video information input unit ill, the upsurge degree acquisition unit 120 acquires at least one of the value and ratio showing facial expressions of the viewers 30 and the number of the viewers 30 described below as the degree of upsurge.

The upsurge degree acquisition unit 120 acquires the value showing facial expressions of the viewers 30 based on video information whose input is received by the video information input unit 111. The technology to acquire the value showing facial expressions of the viewers 30 is not specifically limited. Such a technology is described, for example, at “Sony Corporation homepage, [online], [Search on Jun. 11, 2008], Internet <URL: http://www.sony.jp/products/Consumer/DSC/DSC-T200/feat1.html>”.

The upsurge degree acquisition unit 120 also acquires the ratio of the time in which the lines of sight of the viewers 30 are on the video display surface of the monitor 19 to the time in which the viewers 30 view program content as the degree of upsurge based on video information whose input is received by the video information input unit 111. The technology to detect the lines of sight of the viewers 30 is not specifically limited. Such a technology is described, for example, at “Prof. Kenzo Kurihara et al., [online], [Search on Jun. 11, 2008], Internet <URL: http://joint.idec.or.jp/koryu/020426_{—}2.php>”.

The upsurge degree acquisition unit 120 also acquires the number of the viewers 30 as the degree of upsurge based on video information whose input is received by the video information input unit 111.

If the viewer information input unit 110 has the voice information input unit 112, the upsurge degree acquisition unit 120 acquires at least one of the volume of voice of the viewers 30 and the pitch of voice of the viewers 30 described below as the degree of upsurge.

The upsurge degree acquisition unit 120 also acquires the volume of voice of the viewers 30 as the degree of upsurge based on voice information whose input is received by the voice information input unit 112.

The upsurge degree acquisition unit 120 also acquires the pitch of voice of the viewers 30 as the degree of upsurge based on voice information whose input is received by the voice information input unit 112.

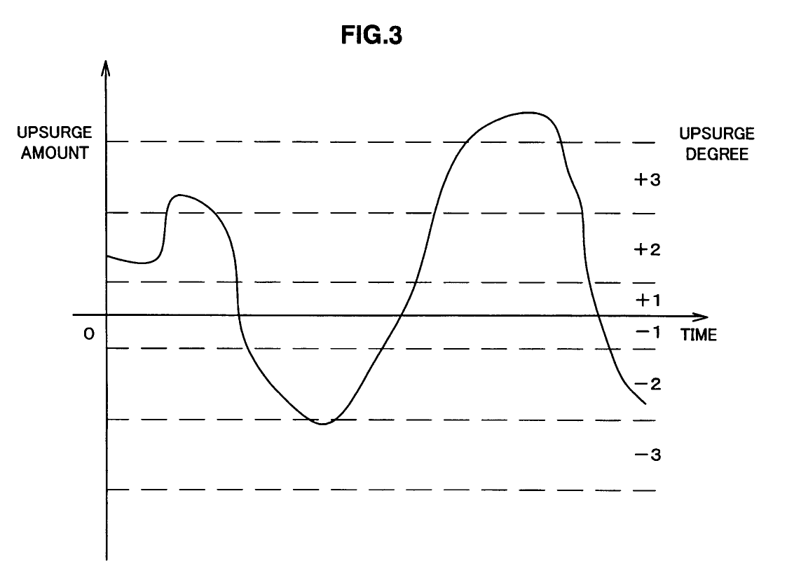

If a plurality of degrees of upsurge is acquired, the upsurge degree acquisition unit 120 may acquire a value obtained by multiplying the plurality of acquired degrees of upsurge as a new degree of upsurge. A detailed description of an algorithm to calculate the degree of upsurge will be described later with reference to FIG. 3. Incidentally, the degree of upsurge may be the number of the viewers 30, volume of voice, pitch of voice or the like itself acquired by the upsurge degree acquisition unit 120, or what is obtained by dividing the number of the viewers 30, volume of voice, or pitch of voice into a plurality of stages.

The upsurge degree acquisition unit 120 is constituted by a CPU (Central Processing Unit) or the like. In this case, the function of the upsurge degree acquisition unit 120 is realized by a program stored in a ROM (Read Only Memory) or the like being expanded into a RAM (Random Access Memory) or the like and the program expanded in the RAM being executed by the CPU. The upsurge degree acquisition unit 120 may also be constituted, for example, by dedicated hardware or the like.

The threshold storage unit 140 is used to store threshold values. The threshold storage unit 140 is constituted, for example, by a RAM, HDD (Hard Disk Drive), or the like.

The program information storage unit 150 is used to store program information such as highlight information, classification information, and evaluation information and the like described later. The program information storage unit 150 is constituted, for example, by a RAM, HDD or the like.

The highlight extraction unit 130 is used to extract highlights of program content based on the degree of upsurge acquired by the upsurge degree acquisition unit 120.

Furthermore, the highlight extraction unit 130 may compare the degree of upsurge acquired by the upsurge degree acquisition unit 120 and the threshold value stored in the threshold storage unit 140. In this case, the highlight extraction unit 130 stores information associating the time when the degree of upsurge exceeds a threshold value or when the degree of upsurge falls below the threshold value with program identification information that is attached to program content and makes the program content 192 identifiable in the program information storage unit 150 as highlight information. Here, program identification information may be made to be notified, for example, from the program identification information reproduction unit 193 that makes the program content 192 being reproduced identifiable. Timing for notification may be, for example, when the reproduction unit 193 starts reproduction of the program content 192, but is not specifically limited. The time is, for example, an elapsed time of reproduction from the start of program content and if the time continues for a predetermined time, information associating the start time and end time thereof with program identification information may be stored in the program information storage unit 150 as highlight information. In this manner, highlights of program content are extracted.

The highlight extraction unit 130 may select a new degree of upsurge acquired by the upsurge degree acquisition unit 120 for comparison.

The highlight extraction unit 130 is constituted by a CPU or the like. In this case, the function of the highlight extraction unit 130 is realized by a program stored in a ROM or the like being expanded into a RAM or the like and the program expanded in the RAM being executed by the CPU. The highlight extraction unit 130 may also be constituted, for example, by dedicated hardware or the like.

If the viewer information input unit 110 has the video information input unit 111, the classification information acquisition unit 160 is used to acquire at least one of intensity of activity in program content and attribute information (information indicating the number, age, sex and the like) of the viewers 30 based on video information. Then, the classification information acquisition unit 160 stores information associating the acquired information with program identification information that is attached to program content and makes the program content identifiable in the program information storage unit 150 as classification information. Intensity of activity in program content may be determined, for example, when the lines of sight of the viewers 30 move within the range of the monitor 19, in accordance with the magnitude of a movement speed after measuring the movement speed thereof. The age and the sex may be determined, for example, from video only, instead of matching with advanced registration information of the viewers 30.

The technology to detect the age of the viewers 30 is not specifically limited. Such a technology is described, for example, at “Sony Corporation homepage, [online] , [Search on Jun. 11, 2008], Internet <URL: http://www.sony.jp/products/Consumer/DSC/DSC-T300/feat1.html>”.

The technology to detect the sex of the viewers 30 is not specifically limited. Such a technology is described, for example, at “[online], [Search on Jun. 11, 2008], Internet <URL: http://www.jst.go.jp/chiiki/kesshu/seika/c-h11-gifu/tech/ct-h11-gifu-2.html>”. At this site, a technology to detect the age of the viewers 30 is also described.

This technology is also described, for example, at “Softopia Japan Foundation homepage, [online], [Search on Jun. 11, 2008], Internet <URL:http://www.softopia.or.jp/rd/hoip.html>”. At this site, technologies to detect the age and lines of sight of the viewers 30 are also described.

If the viewer information input unit 110 has the voice information input unit 112, the classification information acquisition unit 160 may be used to acquire information about the sex of the viewers 30 based on the voice information. In this case, the classification information acquisition unit 160 stores information associating the acquired information with program identification information that is attached to program content and makes the program content identifiable in the program information storage unit 150 as classification information. Thus, the microphone 12 is used to play the role of assisting in classification/evaluation by the camera 11 and used to determine, when the viewers 30 smile, how far the degree of smiling and when the viewers 30 show a tearful face, whether the viewers 30 cry or sob. The microphone 12 is also used to determine the sex and the like.

The classification information acquisition unit 160 is constituted by a CPU or the like. In this case, the function of the classification information acquisition unit 160 is realized by a program stored in a ROM or the like being expanded into a RAM or the like and the program expanded in the RAM being executed by the CPU. The classification information acquisition unit 160 may also be constituted, for example, by dedicated hardware or the like.

The classification information acquisition unit 160 classifies the program content 192 by integrating each piece of the above information. The classification information acquisition unit 160 can classify, for example, the program content 192 of “animation X” from information of “younger than teens”, “male”, “frequent movement of sight line”, “burst of laughter”, and “animation X” into “uproarious animation with action favored by boys younger than teens”.

The classification information acquisition unit 160 can also classify, for example, the program content 192 of “drama Y” from information of “thirties”, “female”, “infrequent movement of sight line”, “concentrated”, and “drama” into “calm drama Y favored by females in their thirties”.

The evaluation information acquisition unit 170 is used to store information associating the degree of upsurge acquired by the upsurge degree acquisition unit 120 with the time and program identification information that is attached to program content and makes the program content identifiable in the program information storage unit 150 as evaluation information.

The evaluation information acquisition unit 170 defines upsurge conditions expressed numerically, for example, from a smiling face, laughter, tearful face, tearful voice, or serious face and the chronological records thereof as the “degree of upsurge”. The evaluation information acquisition unit 170 defines quality as the program content 192 expressed numerically from the time average of the “degree of upsurge” and information about the total number and ratio of the viewing viewers 30 as a “program evaluation”. When selecting the program content 192, the viewers 30 use the “program evaluation”.

The evaluation information acquisition unit 170 is constituted by a CPU or the like. In this case, the function of the evaluation information acquisition unit 170 is realized by a program stored in a ROM or the like being expanded into a RAM or the like and the program expanded in the RAM being executed by the CPU. The evaluation information acquisition unit 170 may also be constituted, for example, by dedicated hardware or the like.

Information (highlight information, classification information, and evaluation information) stored in the program information storage unit 150 by the highlight extraction unit 130, the classification information acquisition unit 160, and the evaluation information acquisition unit 170 can be individually handled by each monitor 19 and each connected recording/reproduction apparatus 40. On the other hand, the above information is handled by the server 60 connected to the network 50 as collective knowledge. Accordingly, more precise information can be given to the viewers 30 as feedback. Information about the collective knowledge can also be used for program production and advertisement within the range of personal information protection.

The transmission unit 180 is used to transmit information stored in the program information storage unit 150 to the server 60 via the network 50. The transmission unit 180 is constituted, for example, by a communication interface or the like. Furthermore, the transmission unit 180 may be used to acquire EPG information generally used in TV or EPG link information from the server 60 in the network k 50 and to acquire information about performers of the program content 192, classification created by the provider side and the like.

### <<Algorithm for Calculating the Degree of Upsurge>>

An algorithm for calculating the degree of upsurge according to the present embodiment will be described.

FIG. 3 is a diagram illustrating an algorithm for calculating the degree of upsurge according to the present embodiment. An example of the algorithm for calculating the degree of upsurge will be described with reference to FIG. 3 (Other figures are also referenced if necessary).

Here, each parameter to calculate the degree of upsurge is set as follows:

Ratio e [%9 of the time during which the lines of sight of the viewers 30 are within the monitor 19

Smiling face level s (−5: wailing, −3: tearful face, 0: serious face, +3: smiling face, +5: great laughter)

Voice volume level v of viewers (0: no voice, −5: loud voice)

Upsurge amount=s×v×e (average in the unit time)

Like a graph shown in FIG. 3, the degree of upsurge is assumed to be ranked between −3 (wailing) and +3 (great laughter) for each upsurge amount.

For example, a case can be considered in which the degree of upsurge of −3 is set as a climax and that of +3 as great laugher so that both are detected as highlight scenes. Moreover, by using a relative value, instead of an absolute value, of the upsurge amount, highlights can also be detected from content whose absolute value of the upsurge amount is small.

### <<Flow of Processing Performed by the Information Processing Apparatus 10>>

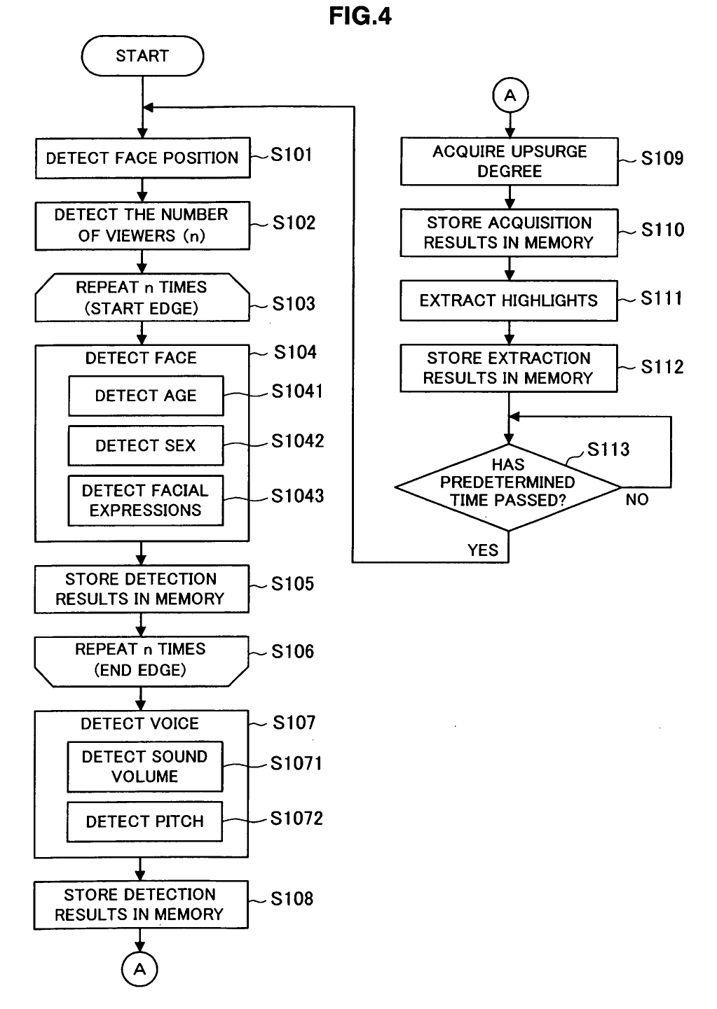

FIG. 4 is a flow chart showing the flow of processing performed by an information processing apparatus according to the present embodiment. Processing performed by the information processing apparatus according to the present embodiment will be described with reference to FIG. 4 (Other figures are also referenced if necessary).

The video information input unit 111 receives input of video information of the viewers 30 via the camera 11 as viewer information. Based on the video information whose input is received by the video information input unit 111, the upsurge degree acquisition unit 120 detects the positions of the faces of the viewers 30 (step S101). The video information input unit 111 also detects the number of faces of the viewers 30 as the number of the viewers 30 (step S102).

Subsequently, repetitive processing of step S103 to step S106 is performed. As an example of face detection processing (step S104), the classification information acquisition unit 160 detects the age of the viewers 30 (step S1041). Further, as an example of face detection processing (step S104), the classification information acquisition unit 160 detects the sex of the viewers 30 (step S1042). Further, as an example of face detection processing (step S104), the upsurge degree acquisition unit 120 detects facial expressions of the viewers 30 (step S1043). Detection results are stored in a memory (program information storage unit 150) (step S105).

The voice information input unit 112 receives input of voice information of the viewers 30 via the microphone 12 as viewer information. As an example of voice detection processing (step S107), the upsurge degree acquisition unit 120 detects the sound volume (volume of voice) of the viewers 30 based on voice information whose input is received by the voice information input unit 112 (step S1071). Further, as an example of voice detection processing (step S107), the upsurge degree acquisition unit 120 detects the pitch (voice pitch) of the viewers 30 based on voice information whose input is received by the voice information input unit 112 (step S1072). Detection results are stored in the memory (program information storage unit 150) (step S108).

The upsurge degree acquisition unit 120 acquires the volume of voice, voice pitch, value indicating facial expressions, number and the like of the viewers 30 as the degree of upsurge (step S109). Acquisition results are stored in the memory (program information storage unit 150) (step S110).

Based on the degree of upsurge acquired by the upsurge degree acquisition unit 120, the highlight extraction unit 130 extracts highlights of the program content 192 (step Sill). The highlight extraction unit 130 stores extraction results in the memory (program information storage unit 150) (step S112). When a predetermined time passes (“YES” at step S113), processing returns to step S101. For example, by waiting until the predetermined time passes in this manner, processing of step S101 to step S112 is repeatedly performed for each frame of video shot by the camera 11.

### <<Modification of a System According to the Present Embodiment>>

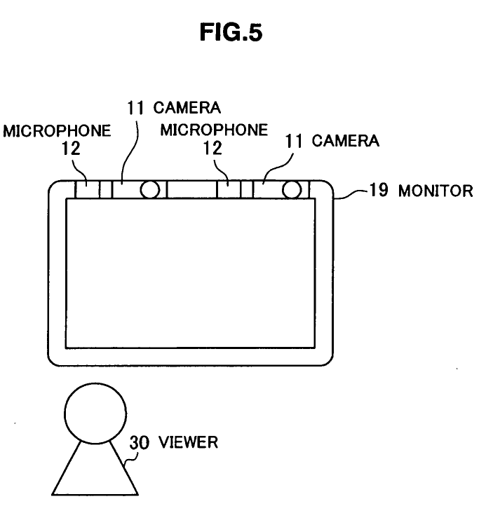

FIG. 5 is a diagram showing a modification of a system according to the present embodiment. The modification of the system according to the present embodiment will be described with reference to FIG. 5 (Other figures are also referenced if necessary).

In the example in FIG. 5, two units of the camera 11 and two units of the microphone 12 are provided in the monitor 19. By providing a plurality of the cameras 11 in this manner, the positions and lines of sight of the viewers 30 are considered to become more easily detectable. Further, by providing a plurality of the microphones 12, the voices of the viewers 30 are considered to become more easily detectable.

Furthermore, when one unit of the camera 11 is used, detection of the faces or lines of sight may become less precise due to the angle of the face or an influence of hair. By using two or more units of the camera 11 and averaging results thereof, detection that varies little and is more precise becomes possible.

When the plurality of the cameras 11 is present, a plurality of the video information input units 111 is present so that input of video information of the viewers 30 is received via each of the plurality of the cameras 11. When the plurality of the microphones 12 is present, a plurality of the voice information input units 112 is present so that input of voice information of the viewers 30 is received via each of the plurality of the microphones 12.

### <<Effects Achieved by the Present Embodiment>>

In related art, program content has been evaluated on an audience rating basis with reference to the viewing time of the program content. According to the present embodiment, on the other hand, program content is classified and evaluated and highlights thereof are detected by identifying emotions of viewers. Accordingly, the present embodiment achieves superior effects shown below.

1) A viewer can select program content on the basis of information based on upsurge conditions of a plurality of viewers including the viewer himself (herself).

2) Program content suiting a viewer's preference can be selected based on attributes (age, sex) of the viewer and those of program content. The selection here includes, in addition to selections made by the viewer himself (herself), recommendations of program content made by a system.

3) When viewing of program content is desired, but an adequate time may not be reserved or program content is desired to be viewed in a short time, the program content can be viewed by selecting highlight portions on the basis of upsurge conditions. Moreover, extraction of only highlight portions can be left to a system, which are then provided as a sequence of content. Using this function, the viewing time of viewers can be shortened.

4) By performing information processing of information from many viewers on the server 60 in the network 50, preferences of many viewers are incorporated into upsurge information as collective knowledge. Moreover, by using the upsurge information, the viewer can select program content suiting viewer's preferences with higher precision.

5) More appropriate program content for target viewers can be produced by attribute (age, sex) information of viewers being used by producers of program content.

6) More tageted advertisements (CM) can be developed by using attribute (age, sex) information of viewers for advertisements.

7) Since attribute (age, sex) information of viewers is determined only from video acquired by a camera, there is no need for advanced registration or the like of face information by viewers.

The present application contains subject matter related to that disclosed in Japanese Priority Patent Application JP 2008-172594 filed in the Japan Patent Office on Jul. 1, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a viewer information input unit that receives input of information about a viewer viewing reproduced program content as viewer information by watching video displayed on a monitor or listening to a voice output from a speaker;
an upsurge degree acquisition unit that acquires a degree of upsurge of the viewer based on the viewer information whose input is received by the viewer information input unit; and
a highlight extraction unit that extracts highlights of the program content based on the degree of upsurge acquired by the upsurge degree acquisition unit.

2. The information processing apparatus according to claim 1, wherein the viewer information input unit includes at least one of a video information input unit that receives input of video information of the viewer via a camera as the viewer information, and
a voice information input unit that receives input of voice information of the viewer via a microphone as the viewer information.

3. The information processing apparatus according to claim 2, further comprising:
a threshold storage unit that stores a threshold value, wherein the highlight extraction unit extracts highlights of the program content by comparing the degree of upsurge acquired by the upsurge degree acquisition unit and the threshold value stored in the threshold storage unit and storing information associating a time when the degree of upsurge exceeds the threshold value or a time when the degree of upsurge falls below the threshold value with program identification information that is attached to the program content and makes the program content identifiable in a program information storage unit as highlight information.

4. The information processing apparatus according to claim 3, wherein the upsurge degree acquisition unit acquires at least one of a value indicating facial expressions of the viewer,
a ratio of a time in which the viewer's eyes are on a video display surface of the monitor to that in which the viewer views the program content, and
the number of viewers based on the video information as the degree of upsurge when the viewer information input unit has the video information input unit.

5. The information processing apparatus according to claim 3, wherein the upsurge degree acquisition unit acquires at least one of a volume of voice of the viewer, and
a voice pitch of the viewer based on the voice information as the degree of upsurge, when the viewer information input unit has the voice information input unit.

6. The information processing apparatus according to claim 3, wherein
the upsurge degree acquisition unit acquires, when a plurality of the degrees of upsurge is acquired, a value obtained by multiplying the plurality of the degrees of upsurge as the new degree of upsurge, and
the highlight extraction unit sets the new degree of upsurge acquired by the upsurge degree acquisition unit as a target of the comparison.

7. The information processing apparatus according to claim 3, further comprising:
a classification information acquisition unit that acquires, at least one of intensity of activity in the program content, the number of the viewers, and information indicating an age and a sex based on the video information and stores information associating the acquired information with the program identification information that is attached to the program content and makes the program content identifiable in the program information storage unit as classification information when the viewer information input unit has the video information input unit.

8. The information processing apparatus according to claim 3, further comprising:
a classification information acquisition unit that acquires information indicating a sex of the viewer based on the voice information and stores information associating the acquired information with the program identification information that is attached to the program content and makes the program content identifiable in the program information storage unit as classification information when the viewer information input unit has the voice information input unit.

9. The information processing apparatus according to claim 3, further comprising:
an evaluation information acquisition unit that stores information associating the degree of upsurge acquired by the upsurge degree acquisition unit with the time and the program identification information that is attached to the program content and makes the program content identifiable in the program information storage unit as evaluation information.

10. The information processing apparatus according to any of claims 7 to 9, further comprising:
a transmission unit that transmits information stored in the program information storage unit to a server via a network.

11. The information processing apparatus according to claim 3, wherein
the video information input units receive input of video information of the viewer via each of a plurality of cameras when a plurality of the video information input units is present, and the voice information input units receive input of voice information of the viewer via each of a plurality of microphones when a plurality of voice information input units is present.

12. An information processing method, comprising the steps of:
receiving input of information about a viewer viewing reproduced program content as viewer information by watching video displayed on a monitor or listening to a voice output from a speaker by a viewer information input unit;
acquiring a degree of upsurge of the viewer based on the viewer information whose input is received by the viewer information input unit by an upsurge degree acquisition unit; and
extracting highlights of the program content based on the degree of upsurge acquired by the upsurge degree acquisition unit by a highlight extraction unit.
